(19) United States
(12) Patent Application Publication
(10) Pub. No.: US 2014/0357266 A1
(43) Pub. Date: Dec. 4, 2014

(54) USING APPLICATION FEEDBACK TO OPTIMIZE PLMN SEARCH

(71) Applicant: NVIDIA Corporation, Santa Clara, CA (US)

(72) Inventors: Greg Heinrich, Sophia Antipolis (FR); Flavien Delorme, Sophia Antipolis (FR); Matthieu Imbault, Sophia Antipolis (FR); Stephen Thomas, Cambridge (GB); Stephen Molloy, Cambridge (GB)

(73) Assignee: NVIDIA Corporation, Santa Clara, CA (US)

(21) Appl. No.: 13/903,120

(22) Filed: May 28, 2013

(51) Int. Cl. H04W 48/16

(52) U.S. Cl. CPC H04W 48/16
USPC 455/434

(57) ABSTRACT

One aspect provides a modem for use at a terminal. The modem comprises a first interface, a second interface, and a processing unit. The first interface is arranged to connect to a network. The second interface is arranged to connect to a host processor on the terminal. The processing unit is arranged to perform a procedure to attempt to connect to the network via the first interface. The processing unit is also arranged to receive an indication of an operating mode that the host processor is operating in from the host processor via the second interface, where the operating mode is one of a plurality of operating modes. The processing unit is further arranged to, in the event of failure of the procedure, repeat performing the procedure at a time controlled in dependence on the received indication.

### TECHNICAL FIELD

The present disclosure relates to a modem for use at a terminal. In particular the present disclosure relates to operating the modem to perform network searches in an attempt to retrieve service.

### BACKGROUND

In known communication systems a modem is used at a terminal to connect to a public land mobile network (PLMN) such as a mobile cellular network (i.e., a 3GPP network or other CDMA network).

There are a number of situations in which the modem is unable to obtain normal service from the PLMN. In these situations the modem attempts to camp on an acceptable cell, irrespective of its PLMN identity, so that emergency calls can be made if necessary. If this attempt is successful then the modem enters a “limited service” state in which it can only attempt to make emergency calls. If this attempt is unsuccessful then the modem will not have network coverage of any kind.

When the modem has no network coverage or is in the “limited service” state, the modem has to regularly perform network searches to try to retrieve full network service. These network searches are sometimes referred to as PLMN searches. The network searches consume battery power of the host terminal. In order to conserve battery life (reduce power consumption) a PLMN search timer which defines a minimum time interval between PLMN searches is increased gradually after a certain number of unsuccessful scans. After the modem has been without full network service for a long period of time, the time interval between PLMN searches can reach long time intervals. If a user tries to use the modem during one of these time intervals between PLMN searches it will fail even if the network coverage has become acceptable again.

### SUMMARY

One aspect provides a modem for use at a terminal. The modem comprises a first interface, a second interface, and a processing unit. The first interface is arranged to connect to a network. The second interface is arranged to connect to a host processor on the terminal. The processing unit is arranged to perform a procedure to attempt to connect to the network via the first interface. The processing unit is also arranged to receive an indication of an operating mode that the host processor is operating in from the host processor via the second interface, where the operating mode is one of a plurality of operating modes. The processing unit is further arranged to, in the event of failure of the procedure, repeat performing the procedure at a time controlled in dependence on the received indication.

Another aspect provides a computer program product for operating a modem for use at a terminal. The modem has a processing unit, a first interface, and a second interface. The first interface is arranged to connect to a network. The second interface is arranged to connect to a host processor on the terminal. The computer program product comprises code embodied on a non-transitory computer-readable medium. The computer program product is configured to perform a procedure to attempt to connect to the network via the first interface. The computer program product is also configured to receive an indication of an operating mode that the host processor is operating in from the host processor via the second interface, where the operating mode is one of a plurality of operating modes. The computer is further configured to, in the event of failure of the procedure, repeat performing the procedure at a time controlled in dependence on the received indication.

Yet another aspect provides a method of operating a modem at a terminal. The modem has a processing unit, a first interface, and a second interface. The first interface is arranged to connect to a network. The second interface is arranged to connect to a host processor on the terminal. The method comprises performing a procedure to attempt to connect to the network via the first interface. The method further comprises receiving an indication of an operating mode that the host processor is operating in from the host processor via the second interface, where the operating mode is one of a plurality of operating modes. The method further comprises, in the event of failure of the procedure, repeat performing the procedure at a time controlled in dependence on the received indication.

Yet another aspect provides a system. The system comprises a terminal, a network, and a modem for use at the terminal. The modem comprises a first interface, a second interface, and a processing unit. The first interface is arranged to connect to a network. The second interface is arranged to connect to a host processor on the terminal. The processing unit is arranged to perform a procedure to attempt to connect to the network via the first interface. The processing unit is also arranged to receive an indication of an operating mode that the host processor is operating in from the host processor via the second interface, where the operating mode is one of a plurality of operating modes. The processing unit is further arranged to, in the event of failure of the procedure, repeat performing the procedure at a time controlled in dependence on the received indication.

### BRIEF DESCRIPTION OF THE DRAWINGS

Reference is now made to the following descriptions taken in conjunction with the accompanying drawings, in which:

FIGS. 1a and 1b are schematic block diagrams of communication systems comprising a host terminal and a modem;

FIG. 2 is a schematic block diagram of a modem for use at a host terminal;

FIG. 3 is a flow chart of a process for performing network searches; and

FIG. 4 is a flow chart of a process for handling an event.

### DETAILED DESCRIPTION

For computer systems implemented on user devices, such as mobile smart phones and tablets, it is important to keep the power consumption of the computer system at a low level because, for example, the power supply to the user device may be limited. One mechanism to conserve power supply levels is for the application processor on the host terminal to operate in a “sleep” mode. While in the low power (or sleep) mode the processor is unable to process information, but typically draws a fraction of the electrical current it draws while operating in an active (or awake) mode, where it does process information. Thus the application processor consumes less power when in the sleep mode.

In known systems, whilst a host processor is in a sleep mode to reduce power consumption, the modem will still implement the known procedure referred to above in an attempt to retrieve network service when the modem has no network coverage or is in the “limited service” state. Whilst the known process referred to above attempts to conserve battery life (reduce power consumption) by gradually increasing the time interval tᵢₙₜₑᵣᵥₐₗ between PLMN searches after a certain number of unsuccessful scans, the modem will still consume power performing the network searches.

Whilst the application processor is in sleep mode (no user action, screen off, applications not running), recovering network service is not critical so PLMN search intervals can be optimized.

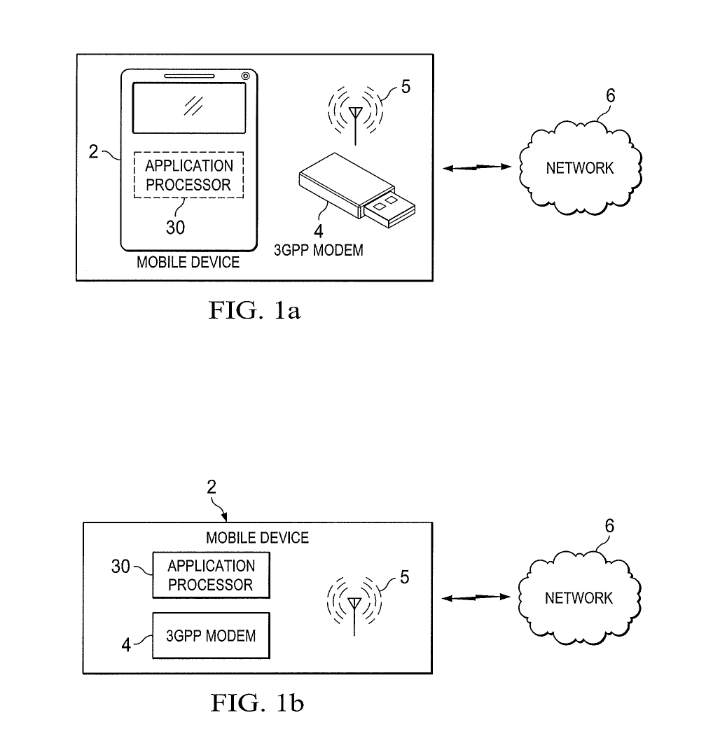

Reference is first made to FIG. 1a and FIG. 1b which illustrate schematic block diagrams of communication systems comprising a host terminal 2 and a modem 4. The host terminal 2 may be a user terminal, and may for example take the form of a laptop computer, tablet style computer, personal digital assistant (PDA) or mobile phone (which may be referred to as a “smart phone”). As shown in FIG. 1a, the modem 4 may for example take the form of a dongle for plugging into the host terminal 2 such that the modem 4 is connected to a host processor 30 (otherwise referred to as an application processor) of the host terminal 2. Alternatively the modem 4 may take the form of a mobile phone handset which, as well as being a conventional mobile telephone, can be connected to the host terminal 2 so as to act as an external cellular modem for the host terminal 2. As shown in FIG. 1a, the modem 4 may be external to the host terminal 2 in that it is a separate unit housed in a separate casing, but which is connected or connectable to the host processor 30 of the host terminal 2 by means of a wired or wireless connection (as well as being removable or being able to be disconnected from the host terminal 2). In another alternative set up, as shown in FIG. 1b, the modem 4 may be internal to the host terminal 2, e.g., taking the form of a wireless module in the host terminal 2. For example, both the modem 4 and host processor 30 may be housed within the same casing of the host terminal 2. For example the modem 4 may be internal to a mobile phone 2, and connected to the host processor 30 of the mobile phone 2 by way of a wired connection. The system could also be a single-chip design where the modem 4 and application processor 30 share the same die.

The system also comprises a PLMN 6 such as a mobile cellular network (i.e., 3GPP network or other CDMA network). Elements of the network 6 are well known to those skilled in the art and are not discussed herein.

For connecting to the network 6, the modem 4 comprises a first interface.

With reference to the communication system shown in FIG. 1a, the first interface may comprise a wireless transceiver, typically in the form of a radio frequency (RF) transceiver and an antenna 5. The first interface of the modem connects via an antenna (not shown) of the mobile cellular network 6 enabling the modem 4 to establish a channel between itself and the mobile cellular network 6.

With reference to the communication system shown in FIG. 1b, the first interface may comprise a wired connection to an interface on the host terminal. The interface on the host terminal may comprise a wireless transceiver, typically in the form of a radio frequency (RF) transceiver and an antenna 5. The interface on the host terminal 2 connects via an antenna (not shown) of the mobile cellular network 6 enabling the modem 4 to establish a channel between itself and the mobile cellular network 6.

This channel referred to above may be referred to as a “context”. For example, if the mobile cellular network is a 3GPP network, then the connection between the modem 4 and a 3GPP network 6 may be called a PDP (Packet Data Protocol) context in 2G or 3G terminology, and an EPS (Evolved Packet System) bearer context in LTE (Long Term Evolution standards) terminology. The physical medium of the connection is typically a radio channel such as a 2G, 3G or LTE radio channel and the protocol that drives it may comprise a set of protocol layers as defined for example by 3GPP standard specifications. The mobile cellular network 6 may be coupled to a further, packet-based network, preferably a wide area internetwork such as the Internet, by way of one or more gateway routers.

For connecting to the host processor 30 on the host terminal 2, the modem 4 comprises a second interface.

With reference to the communication system shown in FIG. 1a, the second interface, between the host processor 30 and modem 4, could for example comprise a wired connection such as a serial interface, for example a Universal Serial Bus (USB), or a short-range wireless transceiver such as an infrared connection or a radio frequency connection (e.g. Bluetooth).

With reference to the communication system shown in FIG. 1b, the second interface, between the host processor 30 and modem 4, could for example comprise a wired connection within the host terminal 2. The second interface may be an interface to a shared memory on the host terminal 2. That is, the host processor 30 and modem may communicate with each other through this shared memory.

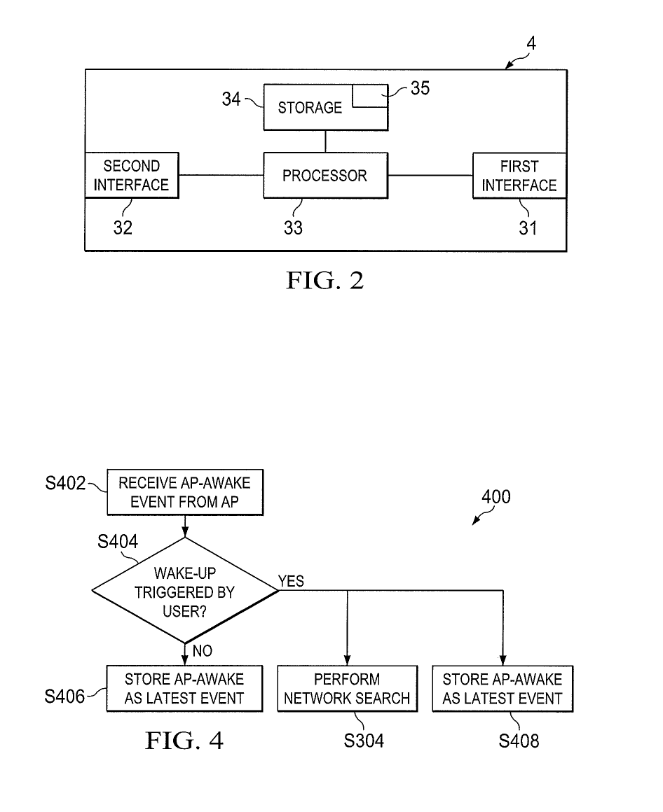

Referring to FIG. 2, the modem 4 may comprise a processor 33 and, operatively coupled to the processor 33, a non-transitory computer-readable storage medium 34 such as a magnetic or electronic memory storing soft-modem code 35. The code 35 on the storage medium 34 is arranged to be executed on the processor 33, so as when executed to send and receive packets between the host 2 and network 6, and to perform the additional operations of the modem 4 as discussed below. However, the possibility of some or all of the modem functionality being implemented in dedicated hardware is not excluded. The modem 4 may be configured in a similar manner to that discussed in relation to FIG. 1 above, but with additional functionality added in accordance with the present invention, an example of which will be discussed in more detail below.

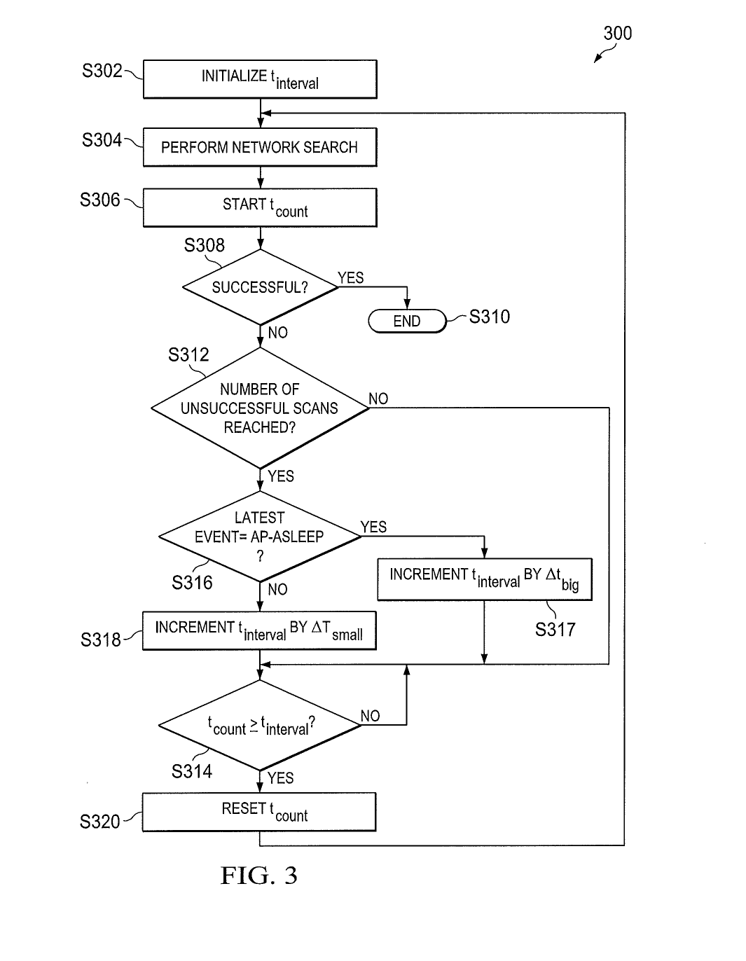

FIG. 3 is flow chart of a process 300 for performing network searches. The process 300 is initiated when the modem 4 has no network coverage or is in the “limited service” state.

The modem 4 is arranged to receive events from the application processor 30 via the second interface 32. When the device 2 is first powered on, the application processor 30 is in an active mode and the application processor 30 transmits an event to the modem 4 indicating that the application processor 30 is in the active mode. The modem 4 may receive an event from the application processor 30 which indicates that the application processor 30 is entering a sleep mode from the active mode. The modem 4 may also receive an event from the application processor 30 which indicates that the application processor 30 has entered the active mode from the sleep mode. When the modem 4 receives an event from the application processor it is arranged to update a parameter “latest event” held by the modem in memory 34 which indicates whether the application processor 30 is in the active mode or in the sleep mode. These events may be received by the modem 4 via the second interface 32 in the form of an AT (ATtention) command. The handling of these events by the modem 4 is described in more detail below.

When the process 300 is initiated the application processor 30 may be in an active mode or in a sleep mode. Thus, when the process 300 is initiated the parameter “latest event” held by the modem in memory 34 may indicate that the application processor 30 is the active mode or in the sleep mode.

At step S302 the parameter tᵢₙₜₑᵣᵥₐₗ which defines a minimum time interval between PLMN searches is initialized to a predetermined value. For example, the parameter tᵢₙₜₑᵣᵥₐₗ may be initialized to 20 seconds, this is merely an example and is not intended to be limiting in any way. The process then proceeds to step S304 where the modem 4 performs a network search in an attempt to retrieve service from network 6. Initial cell search procedures are well known to persons skilled in the art and are therefore not discussed in detail herein.

After performing the network search at step S304 a timer t_{count}, which is used to indicate the time since a network search was performed, is started and the process proceeds to step S308. At step S308 the modem determines whether the network search performed at step S304 was successful, i.e., whether the modem 4 was able to find a suitable cell of network 6 to camp on. If the network search performed at step S304 was successful then the process proceeds to step S310 at which the modem completes the camping process as is known to persons skilled in the art and therefore not discussed in detail herein.

If the network search performed at step S304 was not successful then the process proceeds to an optional step S312. At step S312 the modem determines whether the number of unsuccessful scans since not having full network coverage has reached a predetermined threshold number of unsuccessful scans. The predetermined threshold number can be any integer value greater than or equal to one.

If at step S312, the modem 4 determines that the number of unsuccessful scans since not having full network coverage has not reached a predetermined threshold number of unsuccessful scans then the process proceeds to step S314. At step S314 the process waits until t_{count} is greater than or equal to tᵢₙₜₑᵣᵥₐₗ before proceeding to step S320 where the timer t_{count} is reset before performing a further network search at S304.

If at step S312, the modem 4 determines that the number of unsuccessful scans since not having full network coverage has reached a predetermined threshold number of unsuccessful scans then the process 300 proceeds to step S316.

Step S312 is optional in the sense that the process 300 may be configured to always proceed from step S308 to step S316 when the network search performed at step S304 is unsuccessful. This is equivalent to setting the predetermined threshold number of unsuccessful scans at step S312 to one.

At step S316, the modem 4 checks the parameter “latest event” held by the modem in memory 34 to check the operating mode of the application processor 30.

If the modem 4 determines that the parameter “latest event” held by the modem in memory 34 indicates that the application processor 30 is in active mode the process 300 proceeds to step S318 at which tᵢₙₜₑᵣᵥₐₗ is incremented by a predetermined period of time, tₛₘₐₗₗ. That is, at step S318 a constant (tₛₘₐₗₗ) is added to tᵢₙₜₑᵣᵥₐₗ (this may be the initialized value of tᵢₙₜₑᵣᵥₐₗ or a value of tᵢₙₜₑᵣᵥₐₗ that has already been incremented) to arrive at a new value of tᵢₙₜₑᵣᵥₐₗ. The process 300 then proceeds to step S314, at step S314 the process 300 waits until t_{count} is greater than or equal to tᵢₙₜₑᵣᵥₐₗ (i.e., the incremented time interval) before proceeding to step S320 where the timer t_{count} is reset before performing a further network search at S304.

If at step S316 the modem 4 determines that the parameter “latest event” held by the modem indicates that the application processor 30 is in sleep mode the process proceeds to step S317.

At step S317 the modem 4 optimizes the PLMN search interval. For example, at step S317 the interval, tᵢₙₜₑᵣᵥₐₗ, is incremented by a period of time t_{big}, wherein t_{big}>tₛₘₐₗₗ. That is, at step S317 a constant (t_{big}) is added to tᵢₙₜₑᵣᵥₐₗ (this may be the initialized value of tᵢₙₜₑᵣᵥₐₗ or a value of tᵢₙₜₑᵣᵥₐₗ that has already been incremented) to arrive at a new value of tᵢₙₜₑᵣᵥₐₗ. The process 300 then proceeds to step S314. At step S314 the process 300 waits until t_{count} is greater than or equal to tᵢₙₜₑᵣᵥₐₗ (i.e., the incremented time interval) before proceeding to step S320 where the timer t_{count} is reset before performing a further network search at S304.

Whilst FIG. 3 illustrates an arithmetic progression of the interval, tᵢₙₜₑᵣᵥₐₗ, at step S318 using the constant tₛₘₐₗₗ whilst the application processor 30 is in the active mode and at step S317 using the constant t_{big} whilst the application processor 30 is in the sleep mode. In an alternative embodiment, a geometric progression of the interval, tᵢₙₜₑᵣᵥₐₗ may be implemented at step S318 whilst the application processor 30 is in the active mode and at step S317 whilst the application processor 30 is in the sleep mode.

In this alternative embodiment, whilst the application processor 30 is in the active mode, at step S318 a constant (Xₛₘₐₗₗ) is multiplied with tᵢₙₜₑᵣᵥₐₗ (this may be the initialized value of tᵢₙₜₑᵣᵥₐₗ or a value of tᵢₙₜₑᵣᵥₐₗ that has already been incremented) to arrive at a new value of tᵢₙₜₑᵣᵥₐₗ. Whilst the application processor 30 is in the sleep mode, at step S317 a constant (X_{big}) is multiplied with tᵢₙₜₑᵣᵥₐₗ (this may be the initialized value of tᵢₙₜₑᵣᵥₐₗ or a value of tᵢₙₜₑᵣᵥₐₗ that has already been incremented) to arrive at a new value of tᵢₙₜₑᵣᵥₐₗ, wherein X_{big}>Xₛₘₐₗₗ.

In accordance with the process 300, whilst the application processor 30 is in sleep mode the power consumption of the device 2 is optimized by optimizing the interval between PLMN searches.

Whilst performing the process 300, the modem 4 may receive an event (e.g., an AT command AT+CSLEEP) from the application processor 30 which indicates that the application processor 30 is entering a sleep mode from an active mode whilst performing the process 300. In response to receiving this type of event, the modem 4 is arranged to update the parameter “latest event” held by the modem to indicate that the application processor 30 is in a sleep mode. Thus, if the modem 4 has to check the parameter “latest event” held by the modem to check the operating mode of the application processor 30 at step S316 during the process 300, the modem is able to control the increment of tᵢₙₜₑᵣᵥₐₗ taking into account whether the application processor 30 is in an active mode or a sleep mode.

In a similar manner, whilst performing the process 300, the modem 4 may receive an event (e.g., an AT command AT+CAWAKE) from the application processor 30 which indicates that the application processor 30 has entered an active mode from a sleep mode. In response to receiving this type of event, the modem 4 is arranged to update the parameter “latest event” held by the modem to indicate that the application processor 30 is in an active mode. Thus, if the modem 4 has to check the parameter “latest event” held by the modem in memory 34 to check the operating mode of the application processor 30 at step S316 during the process 300, the modem is able to control the increment of tᵢₙₜₑᵣᵥₐₗ taking into account whether the application processor 30 is in an active mode or a sleep mode.

It will be appreciated that after the modem 4 has not had full network coverage for a long period of time, the time interval tᵢₙₜₑᵣᵥₐₗ between PLMN searches can reach long time intervals following the increments at step S317 whilst the application processor 30 is in a sleep mode. If a user of the device 2 manually awakes the application processor 30 and tries to use the modem 4 whilst the modem is waiting until t_{count} is greater than or equal to tᵢₙₜₑᵣᵥₐₗ at step S314 before performing a network search the attempt may fail even if the network coverage has become acceptable again.

A process 400 is now described with reference to FIG. 4 which addresses this scenario. The modem 4 is arranged to perform the process 400 in parallel to performing the process 300 when the modem 4 receives an event from the application processor 30 which indicates that the application processor 30 has entered an active mode from a sleep mode.

At step S402 the modem 4 receives an event from the application processor 30 via the second interface 32 which indicates that the application processor 30 has entered an active mode from a sleep mode. In response to receiving this type of event at step S402, at step S404, the modem 4 is arranged to determine whether the transition from the application processor 30 operating in the sleep mode to operating in the active mode was triggered by a manual input by a user of the device 2 (i.e. pressing a keypad or touching a display of the device 2).

The application processor 30 may, for example, insert a parameter in the event indicating that the application processor 30 has entered the active mode from the sleep mode which is transmitted to the modem 4, the parameter indicating that the transition from the application processor 30 operating in the sleep mode to operating in the active mode was triggered by a manual input by a user of the device 2. For example the application processor 30 may insert the parameter in the event if the application processor 30 detects that it entered the active mode from the sleep mode based on a manual input that turned on a screen of the device 2. The modem 4 may then make a determination that the transition from the application processor 30 operating in the sleep mode to operating in the active mode was triggered by a manual input by a user of the device 2 at step S404 based on receiving this parameter.

The application processor 30 may, for example, insert a parameter in the event indicating that the application processor 30 has entered the active mode from the sleep mode which is transmitted to the modem 4, the parameter indicating that the transition from the application processor 30 operating in the sleep mode to operating in the active mode was not triggered by a manual input by a user of the device 2. The modem 4 may then make a determination that the transition from the application processor 30 operating in the sleep mode to operating in the active mode was not triggered by a manual input by a user of the device 2 at step S404 based on receiving this parameter. Alternatively, in the absence of a parameter indicating that the transition from the application processor 30 operating in the sleep mode to operating in the active mode was triggered by a manual input by a user of the device 2, the modem 4 may then make the determination that the transition from the application processor 30 operating in the sleep mode to operating in the active mode was not triggered by a manual input by a user of the device 2 at step S404.

If the modem 4 determines at step S404 that the transition from the application processor 30 operating in the sleep mode to operating in the active mode was not triggered by a manual input by a user of the device 2 the process 400 proceeds to step S406. For example, the application processor 30 may enter the active mode from operating in the sleep mode responsive to an alarm event or watchdog event (i.e., a periodic interrupt generated by a chip external to the application processor 30 on the host terminal 2). At step S406 the modem 4 is arranged to update the parameter “latest event” held by the modem in memory 34 to indicate that the application processor 30 is in an active mode. Thus, if the modem 4 has to check the parameter “latest event” held by the modem to check the operating mode of the application processor 30 at step S316 during the process 300, the modem is able to control the increment of tᵢₙₜₑᵣᵥₐₗ taking into account whether the application processor 30 is in an active mode or a sleep mode.

If the modem 4 determines at step S404 that the transition from the application processor 30 operating in the sleep mode to operating in the active mode was triggered by a manual input by a user of the device 2 the modem 4 is arranged to perform an immediate network search, i.e., immediately jump to step S304 in the process 300. For example, the modem 4 will perform a network search even if t_{count} is less than tᵢₙₜₑᵣᵥₐₗ at step S314 in the process 300. In addition, at step S408 the modem 4 updates the parameter “latest event” held by the modem to indicate that the application processor 30 is in an awake mode. Thus, if the modem 4 has to check the parameter “latest event” held by the modem to check the operating mode of the application processor 30 at step S316 during the process 300, the modem 4 is able to control the increment of tᵢₙₜₑᵣᵥₐₗ taking into account whether the application processor 30 is in an active mode or a sleep mode.

When a user of the device 2 manually awakes the application processor 30 it is appropriate to trigger an immediate scan as the user may have knowledge that the network coverage should be back to normal (e.g., after exiting a Subway station) or simply wishes to use the modem 4 (e.g., send a message) and may reasonably expect the device 2 to recover network service shortly after waking it up. This prevents an attempt by the user to use the modem 4 failing, due to a large value of tᵢₙₜₑᵣᵥₐₗ following a long period of time in which the modem 4 has not had full network coverage, even when the modem 4 has network coverage.

Embodiments of the invention are applicable to any apparatus comprising an application processor and a modem entity that communicate with each other. For example, the application processor and modem entity may communicate with each other via a serial interface connection or shared memory.

It will be appreciated that the above embodiments have been described only by way of example, and other variants or applications may be apparent to a person skilled in the art given the disclosure herein.

For instance, while embodiments above have been described in relation to certain standards such as 3GPP networks and so forth, these are not intended to be limiting and the present invention may in fact be applied within any communication standard of any mobile cellular network, or of any packet-based network if such a network is involved. Nor do the terms “context” or “channel” imply a specific nature or standard, but can be used to refer to any kind of suitable data conduit or session established between a modem and a network.

Whilst embodiments have been described above with reference to two operating modes of the application processor 30, principles of the invention may extend to cases where the application processor 30 may operate in more than two modes associated with varying degrees of power consumption and the modem may operate to optimize the PLMN search intervals accordingly.

Whilst embodiments have been described above with reference to storing the parameter “latest event” held by the modem in memory 34, it will be appreciated that this parameter may not necessarily be stored on the same physical memory device as the rest of the soft modem code.

Those skilled in the art to which this application relates will appreciate that other and further additions, deletions, substitutions and modifications may be made to the described embodiments.

What is claimed is:

1. A modem for use at a terminal, the modem comprising:
a first interface arranged to connect to a network;
a second interface arranged to connect to a host processor on the terminal; and
a processing unit arranged to:
perform a procedure to attempt to connect to said network via the first interface;
receive an indication of an operating mode that the host processor is operating in from the host processor via the second interface, wherein the operating mode is one of a plurality of operating modes; and
in the event of failure of the procedure, repeat performing said procedure at a time controlled in dependence on said received indication.

2. The modem of claim 1, wherein the processing unit is further arranged to:
maintain a timer associated with a time interval; and
in the event of failure of the procedure, update said time interval and repeat performing said procedure after expiry of said updated time interval.

3. The modem of claim 2, wherein said update comprises increasing said time interval.

4. The modem of claim 3, wherein the plurality of operating modes comprise a first mode and a second mode, wherein the host processor consumes less power when operating in the second mode than when operating in the first mode, and said update comprises adding a predetermined period of time to said time interval, said predetermined period of time being a greater value when the host processor is in the second mode than when the host processor is in the first mode.

5. The modem of claim 3, wherein the plurality of operating modes comprise a first mode and a second mode, wherein the host processor consumes less power when operating in the second mode than when operating in the first mode, and said update comprises multiplying said time interval with a constant, said constant being a greater value when the host processor is in the second mode than when the host processor is in the first mode.

6. The modem of claim 1, wherein in response to receiving an indication from the host processor that the host processor has changed operating mode from a second mode to a first mode, the processing unit arranged to:
determine if the change in operating mode was responsive to a user input at said terminal and if the change in operating mode was responsive to a user input at said terminal, the processing unit arranged to repeat performing said procedure responsive to said determination.

7. The modem of claim 3, wherein in response to receiving an indication from the host processor that the host processor has changed operating mode from a second mode to the first mode, the processing unit arranged to:
determine whether the change in operating mode was responsive to a user input at said terminal and if the change in operating mode was responsive to a user input at said terminal, the processing unit arranged to repeat performing said procedure responsive to said determination regardless of a state of the timer.

8. The modem of claim 6, wherein the processing unit is arranged to determine that the change in operating mode was responsive to a user input at said terminal based on a parameter in said indication.

9. The modem of claim 7, wherein the processing unit is arranged to determine that the change in operating mode was responsive to a user input at said terminal based on a parameter in said indication.

10. The modem of claim 1, wherein in the event of failure of the procedure, the processing unit is arranged to repeat performing said procedure at the time controlled in dependence on said received indication only if a predetermined number of procedures have failed.

11. The modem of claim 2, wherein in the event of failure of the procedure, the processing unit is arranged to repeat performing said procedure at the time controlled in dependence on said received indication only if a predetermined number of procedures have failed, and if the predetermined number of procedures have not failed, the processing unit is arranged to not update said time interval and repeat performing said procedure after expiry of said time interval.

12. The modem of claim 1, wherein the processing unit is arranged to receive said indication from the host processor via the second interface in an Attention (AT) Command.

13. The modem of claim 1, wherein the terminal comprises a housing and the modem is an internal module within said terminal housing.

14. The modem of claim 13, wherein the second interface comprises a wired connector or connection within said terminal housing to connect to the host processor.

15. The modem of claim 13, wherein the first interface connects to a first wireless transceiver of said terminal for connecting to the network.

16. The modem of claim 1, wherein the modem comprises an external unit for use at the terminal.

17. The modem of claim 16, wherein the second interface is a serial interface.

18. The modem of claim 16, wherein the modem comprises a dongle housing, said modem for plugging into said terminal via the second interface.

19. The modem of claim 16, wherein the first interface comprises a first wireless transceiver for connecting to the network.

20. The modem of claim 16, wherein the second interface comprises a second wireless transceiver for connecting to the terminal via a local wireless connection.

21. The modem of claim 1, wherein the modem comprises a mobile phone housing for connecting to said terminal via the second interface, the mobile phone thus being operable as a telephone and as an external wireless cellular modem for the terminal.

22. A computer program product for operating a modem for use at a terminal, the modem having a processing unit, a first interface arranged to connect to a network, a second interface arranged to connect to a host processor on the terminal; wherein the computer program product comprises code embodied on a non-transitory computer-readable medium and configured so as when executed on the processing unit of said modem to:
perform a procedure to attempt to connect to said network via the first interface;
receive an indication of an operating mode that the host processor is operating in from the host processor via the second interface, wherein the operating mode is one of a plurality of operating modes; and
in the event of failure of the procedure, repeat performing said procedure at a time controlled in dependence on said received indication.

23. A method of operating a modem at a terminal, the modem having a processing unit, a first interface arranged to connect to a network, a second interface arranged to connect to a host processor on the terminal, wherein the method comprises:
performing a procedure to attempt to connect to said network via the first interface;
receiving an indication of an operating mode that the host processor is operating in from the host processor via the second interface, wherein the operating mode is one of a plurality of operating modes; and
in the event of failure of the procedure, repeat performing said procedure at a time controlled in dependence on said received indication.

24. A system comprising:
a terminal;
a network; and
a modem for use at the terminal, the modem comprising:
a first interface arranged to connect to a network;
a second interface arranged to connect to a host processor on the terminal; and
a processing unit arranged to:
perform a procedure to attempt to connect to said network via the first interface;
receive an indication of an operating mode that the host processor is operating in from the host processor via the second interface, wherein the operating mode is one of a plurality of operating modes; and
in the event of failure of the procedure, repeat performing said procedure at a time controlled in dependence on said received indication.
